(19) United States
(12) Patent Application Publication
(10) Pub. No.: US 2009/0130376 A1
(43) Pub. Date: May 21, 2009

(54) UNIDIRECTIONAL FIBER MATERIAL AND FABRICATION METHOD

(75) Inventors: Thomas R. Berkel, Troy, IL (US); Panagiotis George, Lake Tapps, WA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 11/943,027

(22) Filed: Nov. 20, 2007

(51) Int. Cl. B32B 5/12; D03D 23/00

(52) U.S. Cl. 428/113; 139/383 R; 428/114

(57) ABSTRACT

A unidirectional fiber material. An illustrative embodiment of the unidirectional fiber material includes a plurality of unidirectional reinforcing fibers, an unbound section provided along the reinforcing fibers and generally free from fill-binding material, a first bound section having a fill-binding material provided along the reinforcing fibers on a first side of the unbound section and a second bound section having a fill-binding material provided along the reinforcing fibers on a second side of the unbound section. A method of fabricating a unidirectional fiber material is also disclosed.

### TECHNICAL FIELD

The disclosure relates to dry unidirectional fiber material which is suitable for a resin infusion process and suitable for material property characterization testing. More particularly, the disclosure relates to a dry unidirectional fiber material and a method of fabricating a dry unidirectional fiber material having bound sections which include fill-binding material and unbound sections which lack fill-binding material and alternate with the bound sections.

### BACKGROUND

In the fabrication of composite materials, it may be necessary to utilize testing methods for material characterization such as to determine mechanical properties of the fabricated materials using Strain Invariant Failure Theory (SIFT) and/or other mechanical property prediction methods. Unidirectional fiber which is used for material characterization testing may include fill-binding materials such as fill direction yarns, veils or thermofused filaments, for example and without limitation. These secondary fill-binding materials may impact basic physical material parameters such as fiber volume and resin density and may adversely affect the tensile, compression and shear test results for determination of strength, modulus and strain invariant properties. Therefore, a unidirectional fiber material having sections or zones which lack secondary fill-binding materials may be useful for material characterization analysis in implementation of mechanical property prediction methods such as SIFT.

### SUMMARY

The disclosure is generally directed to a unidirectional fiber material. An illustrative embodiment of the unidirectional fiber material includes a plurality of unidirectional reinforcing fibers, an unbound section provided along the reinforcing fibers and generally free from fill-binding material, a first bound section having a fill-binding material provided along the reinforcing fibers on a first side of the unbound section and a second bound section having a fill-binding material provided along the reinforcing fibers on a second side of the unbound section.

The disclosure is further generally directed to a method of fabricating a unidirectional fiber material. An illustrative embodiment of the method includes providing a plurality of reinforcing fibers, orienting the reinforcing fibers in generally parallel relationship with respect to each other, applying a fill-binding material to a first length of the reinforcing fibers, applying a fill-binding material to a second length of the reinforcing fibers and leaving a third length of the reinforcing fibers between the first length of the reinforcing fibers and the second length of the reinforcing fibers free from a fill-binding material.

### BRIEF DESCRIPTION OF THE ILLUSTRATIONS

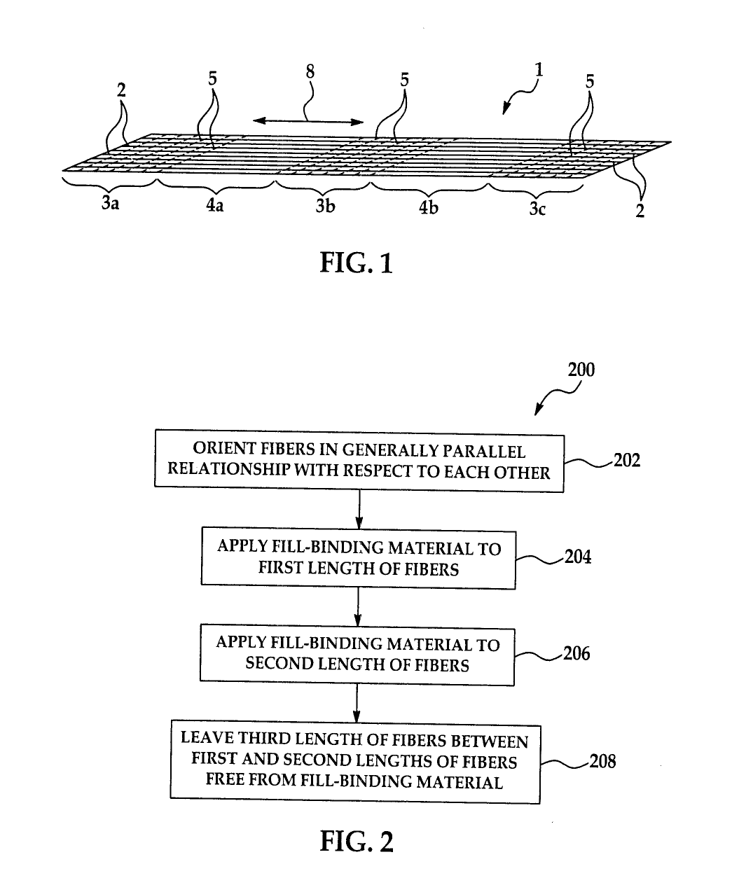

FIG. 1 is a perspective view of a unidirectional fiber material according to an illustrative embodiment of the unidirectional fiber material.

FIG. 2 is a flow diagram which illustrates an illustrative embodiment of a method of fabricating a dry unidirectional fiber material.

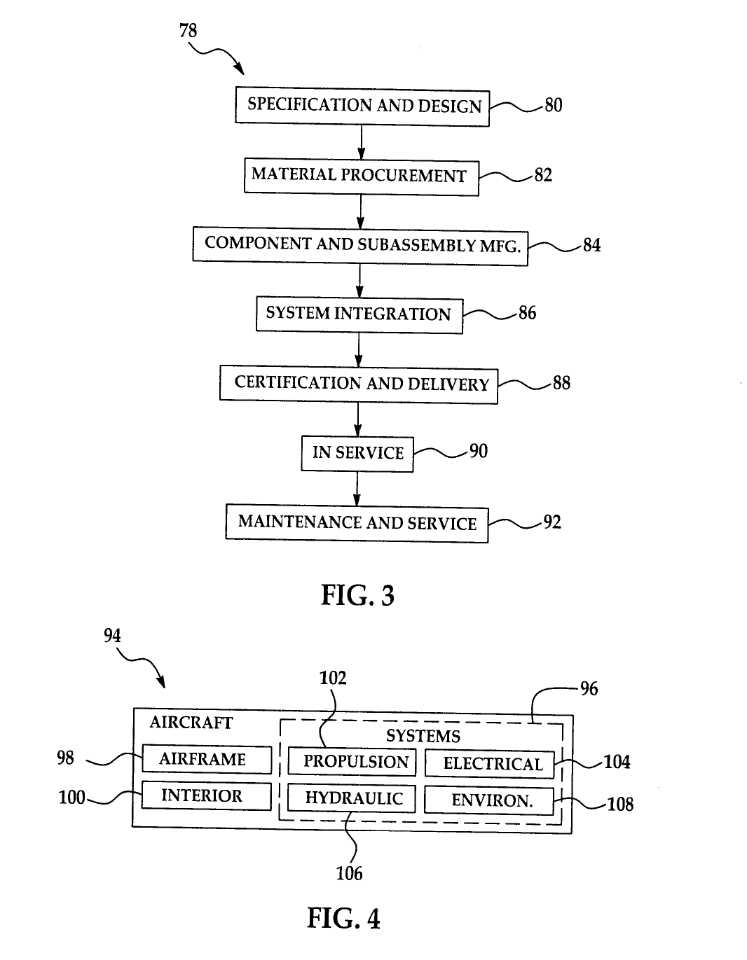

FIG. 3 is a flow diagram of an aircraft production and service methodology.

FIG. 4 is a block diagram of an aircraft.

### DETAILED DESCRIPTION

The disclosure is generally directed to a dry unidirectional fiber material and fabrication of a dry unidirectional fiber material which is suitable for a resin infusion liquid molding process compatible with material property characterization testing using such mechanical property prediction methods such as Strain Invariant Failure Theory (SIFT), for example and without limitation. The dry unidirectional fiber material may include bound sections having fill-binding material and unbound sections which lack fill-binding material and alternate with the bound sections. The fabricated dry unidirectional fiber material may subsequently be subjected to a resin infusion liquid molding process to form a test composite material. The unbound sections which are free of the fill-binding material in the composite may define test zones for extraction of material characterization test specimens.

Referring initially to FIG. 1, an illustrative embodiment of a dry unidirectional fiber material is generally indicated by reference numeral 1. The dry unidirectional fiber material 1 may include multiple unidirectional reinforcing fibers 2 which may be oriented in generally parallel relationship with respect to each other and in generally parallel relationship with respect to a longitudinal axis 8 of the unidirectional fiber material 1. The unidirectional reinforcing fibers 2 may be uniformly-spaced with respect to each other.

The unidirectional fiber material 1 may include a pair of bound sections 3 and at least one unbound section 4 between the bound sections 3. A fill-binding material 5 may be provided in each bound section 3. The fill-binding material 5 may be glass fiber, thermofusable yarn, fill direction yarn, veils, stitches and/or any other suitable fill binder. The fill-binding material 5 may be oriented in generally perpendicular relationship with respect to the unidirectional reinforcing fibers 2. Each unbound section 4 may partially or completely lack the fill-binding material 5. The bound sections 3 may facilitate handling of the unidirectional fiber material 1.

In some embodiments, the unidirectional fiber material 1 may include multiple bound sections 3 and multiple bound sections 4. The bound sections 3 may be disposed in spaced-apart relationship with respect to each other along the longitudinal axis 8 of the unidirectional fiber material 1. The unbound sections 4 may be disposed in spaced-apart relationship with respect to each other along the longitudinal axis 8 of the unidirectional fiber material 1 and may alternate with the bound sections 3. Therefore, each unbound section 4 may be flanked by a pair of bound sections 3. In the illustrative embodiment of the unidirectional fiber material 1 which is shown in FIG. 1, a first unbound section 4a is disposed between a first bound section 3a and a second bound section 3b. A second unbound section 4b is disposed between the second bound section 3b and a third bound section 3c. The sequence of alternating bound sections 3 and unbound sections 4 in any desired number may be repeated for any length of the unidirectional fiber material 1 to be used in test specimens for material characterization.

The unidirectional fiber material 1 may be fabricated using any suitable technique which is known by those skilled in the art. In some fabrication methods, the unidirectional fiber material 1 may be fabricated on a conventional weaving loom (not shown) using fiber tows and spacing of the unidirectional fibers 2 which will provide the desired areal weight of the unidirectional fiber material 1. The unidirectional fibers 2 may be woven with the fill-binding material 5 across the full width of the unidirectional fibers 2 for the required length stabilization during panel molding along the longitudinal axis of the unidirectional fibers 2. The resulting fabric material may then be run through the weaving loom with no fill-binding material 5 for the length required for mechanical testing [PEG1] along the longitudinal axis of the unidirectional fibers 2. This sequence of alternating bound sections or zones with the fill-binding material 5 and unbound sections or zones without the fill-binding material 5 may be repeated any desired number of times to fabricate a selected yardage of the unidirectional fiber material 1 for use in test specimens, for example and without limitation. The fabrication process may be accomplished through the use of manual or pre-programmed means that stop and restart the fill-binding material 5 as required.

Referring next to FIG. 2, a flow diagram 200 which illustrates an illustrative embodiment of a method of fabricating a dry unidirectional fiber material is shown. In block 202, unidirectional reinforcing fibers are oriented in generally parallel relationship with respect to each other. In block 204, a fill-binding material is applied to a first length of the unidirectional fibers. In block 206, a fill-binding material is applied to a second length of the unidirectional fibers. In block 208, a third length of the unidirectional fibers between the first length and the second length of the unidirectional fibers is left free from the fill-binding material.

Referring next to FIGS. 3 and 4, embodiments of the disclosure may be used in the context of an aircraft manufacturing and service method 78 as shown in FIG. 3 and an aircraft 94 as shown in FIG. 4. During pre-production, exemplary method 78 may include specification and design 80 of the aircraft 94 and material procurement 82. During production, component and subassembly manufacturing 84 and system integration 86 of the aircraft 94 takes place. Thereafter, the aircraft 94 may go through certification and delivery 88 in order to be placed in service 90. While in service by a customer, the aircraft 94 may be scheduled for routine maintenance and service 92 (which may also include modification, reconfiguration, refurbishment, and so on).

Each of the processes of method 78 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 4, the aircraft 94 produced by exemplary method 78 may include an airframe 98 with a plurality of systems 96 and an interior 100. Examples of high-level systems 96 include one or more of a propulsion system 102, an electrical system 104, a hydraulic system 106, and an environmental system 108. Any number of other systems may be included. Although an aerospace example is shown, the principles of the invention may be applied to other industries, such as the automotive industry.

The apparatus embodied herein may be employed during any one or more of the stages of the production and service method 78. For example, components or subassemblies corresponding to production process 84 may be fabricated or manufactured in a manner similar to components or subassemblies produced while the aircraft 94 is in service. Also, one or more apparatus embodiments may be utilized during the production stages 84 and 86, for example, by substantially expediting assembly of or reducing the cost of an aircraft 94. Similarly, one or more apparatus embodiments may be utilized while the aircraft 94 is in service, for example and without limitation, to maintenance and service 92.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A unidirectional fiber material, comprising:
a plurality of unidirectional reinforcing fibers;
an unbound section provided along said reinforcing fibers and generally free from fill-binding material;
a first bound section having a fill-binding material provided along said reinforcing fibers on a first side of said unbound section; and
a second bound section having a fill-binding material provided along said reinforcing fibers on a second side of said unbound section.

2. The unidirectional fiber material of claim 1 wherein said reinforcing fibers are generally equally-spaced with respect to each other.

3. The unidirectional fiber material of claim 1 wherein said fill-binding material comprises glass fibers.

4. The unidirectional fiber material of claim 1 wherein said fill-binding material comprises thermofusable yarn.

5. The unidirectional fiber material of claim 1 wherein said fill-binding material comprises fill direction yarn.

6. The unidirectional fiber material of claim 1 wherein said fill-binding material comprises veils.

7. The unidirectional fiber material of claim 1 wherein said fill-binding material is oriented in generally perpendicular relationship with respect to said reinforcing fibers.

8. A unidirectional fiber material, comprising:
a plurality of unidirectional reinforcing fibers;
a plurality of bound sections provided along said reinforcing fibers in spaced-apart relationship with respect to each other and each having a fill-binding material; and
a plurality of unbound sections provided along said reinforcing fibers in alternating relationship with respect to said plurality of bound sections and each generally free from said fill-binding material.

9. The unidirectional fiber material of claim 8 wherein said reinforcing fibers are equally-spaced with respect to each other.

10. The unidirectional fiber material of claim 8 wherein said fill-binding material comprises glass fibers.

11. The unidirectional fiber material of claim 8 wherein said fill-binding material comprises thermofusable yarn.

12. The unidirectional fiber material of claim 8 wherein said fill-binding material comprises fill direction yarn.

13. The unidirectional fiber material of claim 8 wherein said fill-binding material comprises veils.

14. The unidirectional fiber material of claim 8 wherein said fill-binding material is oriented in generally perpendicular relationship with respect to said reinforcing fibers.

15. A method of fabricating a unidirectional fiber material, comprising:
providing a plurality of reinforcing fibers;
orienting said reinforcing fibers in generally parallel relationship with respect to each other;
applying a fill-binding material to a first length of said reinforcing fibers;
applying a fill-binding material to a second length of said reinforcing fibers; and
leaving a third length of said reinforcing fibers between said first length of said reinforcing fibers and said second length of said reinforcing fibers generally free from a fill-binding material. [tb2]

16. The method of claim 15 wherein said orienting said reinforcing fibers in generally parallel relationship with respect to each other comprises placing said reinforcing fibers in equally-spaced relationship with respect to each other.

17. The method of claim 15 wherein said applying a fill-binding material to a first length of said reinforcing fibers and said applying a fill-binding material to a second length of said reinforcing fibers comprises applying glass fibers to said first length of said reinforcing fibers and said second length of said reinforcing fibers, respectively.

18. The method of claim 15 wherein said applying a fill-binding material to a first length of said reinforcing fibers and said applying a fill-binding material to a second length of said reinforcing fibers comprises applying thermofusable yarn to said first length of said reinforcing fibers and said second length of said reinforcing fibers, respectively.

19. The method of claim 15 wherein said applying a fill-binding material to a first length of said reinforcing fibers and said applying a fill-binding material to a second length of said reinforcing fibers comprises applying fill direction yarn to said first length of said reinforcing fibers and said second length of said reinforcing fibers, respectively.

20. The method of claim 15 wherein said applying a fill-binding material to a first length of said reinforcing fibers and said applying a fill-binding material to a second length of said reinforcing fibers comprises applying veils to said first length of said reinforcing fibers and said second length of said reinforcing fibers, respectively.
